(19) United States
(12) Patent Application Publication
(10) Pub. No.: US 2004/0230142 A1
(43) Pub. Date: Nov. 18, 2004

(54) Three dimensional automatic vibrating bed

(76) Inventor: Young-Go Park, Sungnam-Si (KR)

Correspondence Address: Robert E. Bushnell, Suite 300, 1522 K Street, N.W., Washington, DC, 20005, US

(21) Appl. No.: 10/817,927

(22) Filed: Apr. 6, 2004

(30) Foreign Application Priority Data
May 16, 2003 (KR) 2003-0015246

(51) Int. Cl. A61H 23/02

(52) U.S. Cl. 601/51; 601/98; 601/101

(57) ABSTRACT

A vibrating bed, which may vibrate in three dimensions and two dimensions, includes a vibratable plate, a bed frame, a plurality of resilient pillars, a plurality of first tension spring sets, a plurality of second tension spring sets, a first rotary reciprocating mechanism, a second rotary reciprocating mechanism, a first connecting rod adjusting device, a second connecting rod adjusting device, a first piston bracket seating device, and a second piston bracket seating device. The present invention may provide a user with more pleasure and happiness and may be good for the health.

### CLAIM OF PRIORITY

This application makes reference to, incorporates the same herein, and claims all benefits accruing under 35 U.S.C. §119 from an application for THREE-DIMENSIONAL AUTOMATIC VIBRATING BED earlier filed in the Korean Intellectual Property Office on 16 May 2003 and thereby duly assigned Serial No. 20-2003-0015246.

### BACKGROUND OF THE INVENTION 1. Technical Field

The present invention relates to a bed, more particularly a two and three dimensional automatic vibrating bed which vibrates longitudinally and laterally. 2. The Related Art

The present inventor in U.S. Pat. No. 6,682,495 discloses the horizontal motion vibrating bed. However, the bed disclosed in U.S. Pat. No. 6,682,495 vibrates only in one dimension. The present invention improves the invention of U.S. Pat. No. 6,682,495, which is incorporated herein by reference.

### SUMMARY OF THE INVENTION

It is an object of the present invention to provide an improved vibrating bed.

It is another object of the present invention to provide a two dimensional vibrating bed.

It is still another object of the present invention to provide a three dimensional vibrating bed.

It is yet another object of the present invention to provide a bed for escalating extra pleasure of a couple making love on it while the bed is vibrating, fast recovering from fatigue while a person is lying on the vibrating bed, and also exercising aged persons and inpatients who are on it while it is vibrating.

It is further another object of the present invention to provide a vibrating bed which may be used as an usual bed while it is not vibrating.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference numerals indicate the same or similar components, and wherein:

FIG. 1 is a perspective view of an embodiment of the present invention with a shadow view of the vibratable plate;

FIG. 2A is a sectional view taken on line A-A′ of FIG. 1;

FIG. 2B is a sectional view taken on line A-A′ of FIG. 1 with an enlarged detail view of a bearing case, a connecting rod and a “T”-shaped piston bracket;

FIG. 3 is a sectional view taken on line B-B′ of FIG. 1 showing an enlarged detail view of a tension coil spring device;

FIG. 4 is a front view of a cylindrical shape coil spring of a resilient pillar;

FIG. 5 is a front and a top view of a tension coil spring with hooks;

FIG. 6 is a perspective view of the first and second pulleys, a shaft, and a belt attached on the bottom of the stationary plate according to the embodiment; and

FIG. 7 is a perspective view of the “T”-shaped piston bracket.

### DETAILED DESCRIPTION OF THE PREFERRED EMBODIMENTS

The preferred embodiment of the present invention, the three dimensional automatic vibrating bed, comprises seven major parts and four minor parts. The seven major parts include a vibratable plate, a bed frame, a plurality of resilient pillars, a plurality of first tension spring sets, a plurality of second tension spring sets, a first rotary reciprocating mechanism, and a second rotary reciprocating mechanism. The four minor parts include a first connecting rod adjusting device, a second connecting rod adjusting device, a first piston bracket seating device, and a second piston bracket seating device.

### Embodiment 1

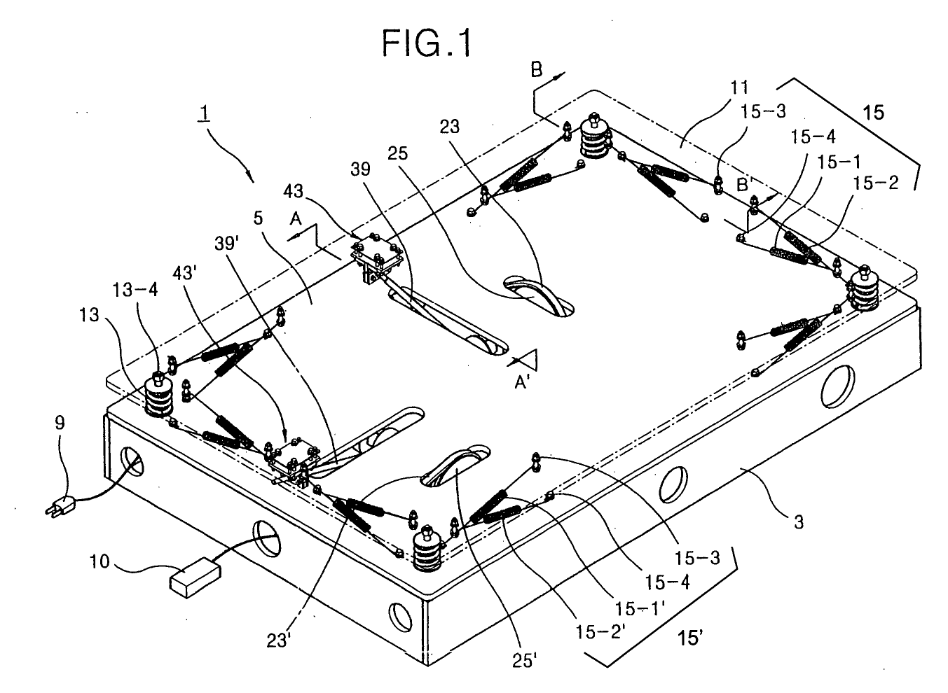

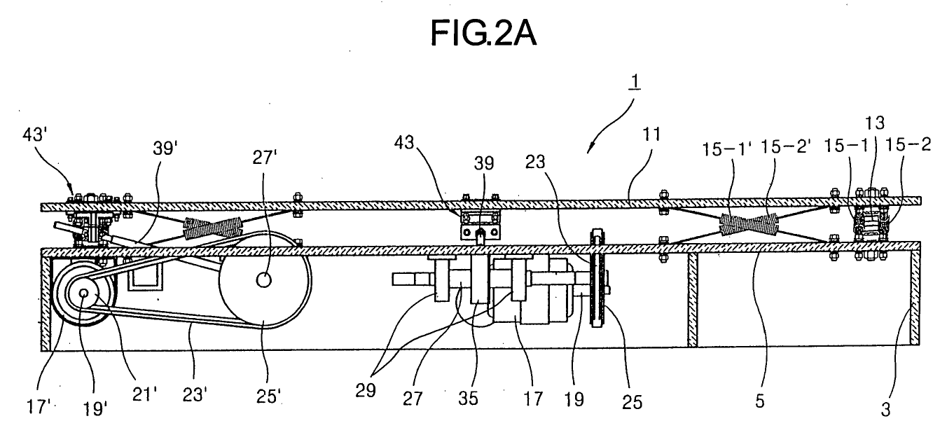

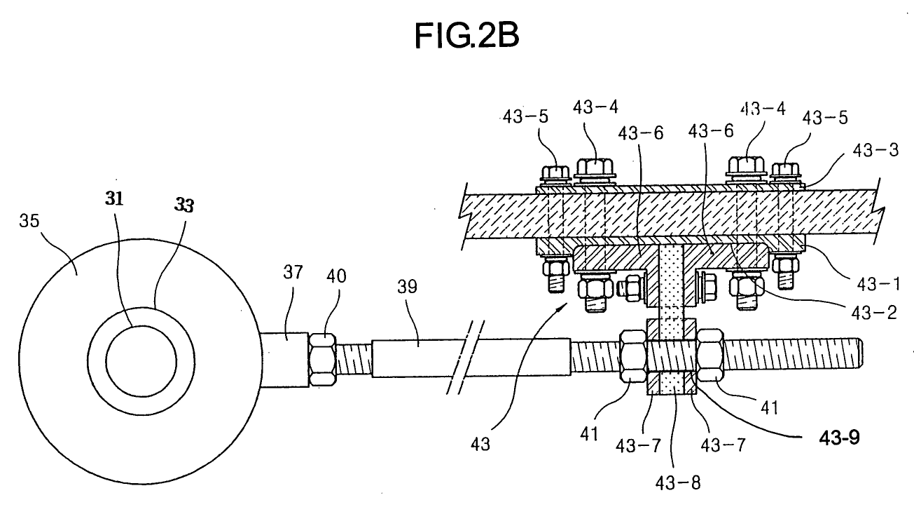

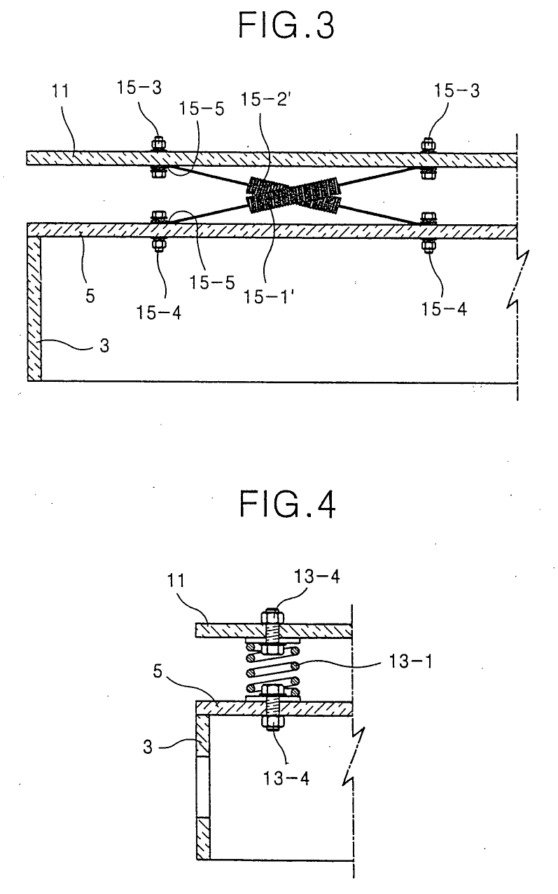

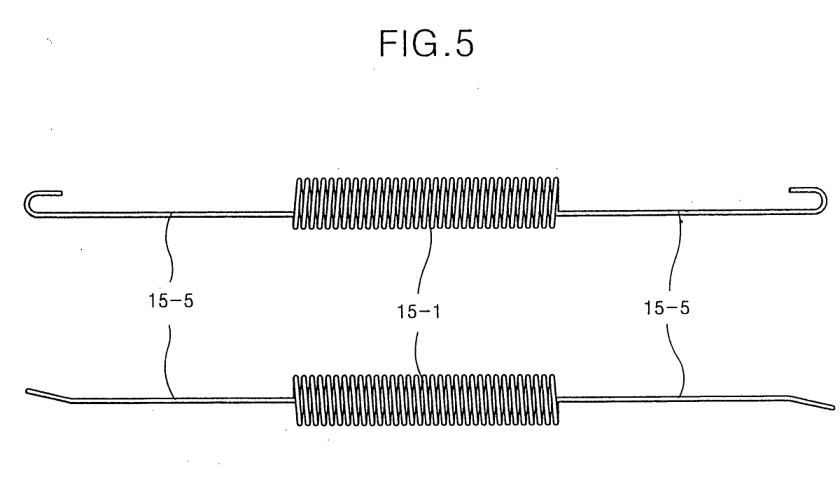

Referring to the drawings, as shown in FIGS. 1 and 2, the first major part, the vibratable plate (11), may be the same size of the conventional bed. The vibratable plate (11) is movably secured on supporting and floating means such as the plurality of resilient pillars (13), preferably represented by cylindrical shaped compressed coil springs.

The second major part, the bed frame (7), includes legs, preferably vertical plates (3) which form a square shape, of which the height is preferably 200-300 mm, and a stationary plate (5) which is solidly secured to the vertical plates (3) at its top side. The stationary plate (5) has preferably 9 elongated holes for passage spaces of the connecting rods (39 for the first rotary reciprocating mechanism, 39′ for the second rotary reciprocating mechanism) and larger shaft pulleys (27, 27′).

The third major part, the plurality of resilient pillars (13), is secured on the stationary plate (5) and the vibratable plate (11) by bolts and nuts(13-4) at their both ends. The resilient pillars (13) support and float the vibratable plate (11), and allow it to vibrate in three dimensions by its free swiveling, contracting, and elongating.

The fourth major part, the plurality of first tension spring sets (15) as shown in the FIG. 1, 3, and 5, includes a first tension coil spring (15-1) and a second tension coil spring (15-2). The first tension spring set is referred to as the tension spring set which is arranged laterally. Each of the first and second tension coil springs has spring hooks (15-5) which are laterally hooked to the vibratable plate (11) and the stationary plate (5), respectively, at their both ends by bolts (15-3) and nuts (15-4).

The fifth major part, the plurality of second tension spring sets (15′) are the same as the first tension spring sets (15) except for that their directions are turned by 90°. That is, the second tension spring set is referred to as the tension spring set which is arranged longitudinally. Each second tension spring set (15′) includes a third tension coil spring (15-3) and a fourth tension coil spring(15-4).

The first and second tension spring sets are mounted for smoother vibration. That means that the inertia force of the vibratable plate (11) and a person on it is compensated, i.e., damped, at the top dead point of the crank by the first tension coil springs (15-1) while the second tension coil springs (15-2) are far most compressed and by the third tension coil springs (15-3) while the fourth tension coil springs (15-4) are far most compressed. That also means that the reduction mechanisms including the pulleys, the shaft, and belts are prevented from the jerking vibratable plate (11), and the jerking noises do not arise.

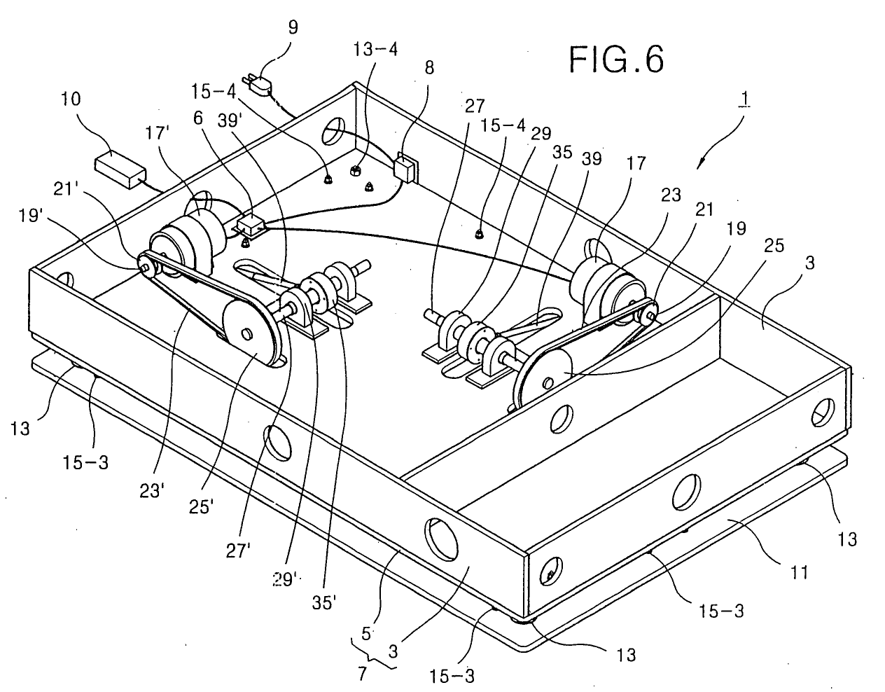

The sixth major part and the seventh major part are the first rotary reciprocating mechanism and the second rotary reciprocating mechanism for vibrating the vibratable plate (11). The first rotary reciprocating mechanism is referred to as the rotary reciprocating mechanism laterally vibrating the vibratable plate, and the second rotary reciprocating mechanism is referred to as the rotary reciprocating mechanism longitudinally vibrating the vibratable plate. As shown in the FIGS. 1, 2A, 2B, and 6, the second rotary reciprocating mechanism for vibrating the vibratable plate (11) is the same as the first rotary reciprocating mechanism except for that its direction is turned by 90°. Each of the preferred first and the second rotary reciprocating mechanisms includes a variable speed motor, a smaller pulley, a belt, a larger pulley, a pulley shaft, a bracket bearing, a couple of brackets, an eccentric crank pin, a crank pin bearing, a bearing case, a rod connecting nut, a connecting rod, a rod tightening nut, and the T-shaped piston bracket. As shown in the FIG. 2A, the connecting rod (39, 39′) preferably reciprocates the vibratable plate (11) laterally and longitudinally by electricity, and these vibrations may make the vibratable plate (11) vertically vibrate. Only one of the first and second rotary reciprocating mechanism may be installed or operated in accordance with a user's preference. When only one of the first and second reciprocating mechanisms is installed or performed, the bed vibrates in two dimensions.

The variable speed motor(17, 17′) is attached on the bottom of the stationary plate (5). The smaller pulley (21, 21′) is secured on the shaft (19, 19′) of the motor (17, 17′). The belt (23, 23′) is engaged with the smaller motor pulley (21, 21′) and a larger shaft pulley (25, 25′) which is secured on a pulley shaft (27, 27′) so that the belt (23,23′) delivers motor power to the pulley shaft (27, 27′) which is rotatably secured on the bottom of the stationary plate (5, 5′) by a couple of brackets (29, 29′). The bracket bearing (not shown in the figure) may be inserted between the bracket (29, 29′) and the pulley shaft (27, 27′). The eccentric crank pin (31, 31′) is provided in the mid-portion of the pulley shaft (27, 27′) between the brackets (29, 29′). The crank pin bearing(33, 33′) is inserted on the crank pin (31, 31′), and the bearing case (35, 35′) is also inserted on the crank pin bearing (33, 33′). The rod connecting nut (37, 37′) is welded radially to the bearing case (35, 35′). A connecting rod (39, 39′) is threaded at its both ends of which one end is inserted into the rod connecting nut (37, 37′) and firmly tightened by a rod tightening nut (40, 40′), and of which the other end is threaded into a through hole (43-9) provided in the vertical portion of the “T”-shaped piston bracket (43,43′). The length of the connecting rod between the rod connecting nut (37, 37′) and the “T”-shaped piston bracket (43, 43′) is adjusted by a pair of connecting rod adjusting nuts (41, 41′). The “T”-shaped piston bracket (43, 43′) is seated in a seat groove (43-2, 43-2′) provided on A “T”-shaped piston bracket seat (43-1,43-1′). The bracket seat (43-1,43-1′) is attached on the lower and lateral end side of the vibratable plate (11) along with a “T”-shaped piston bracket back plate(43-3).

It is remarked that the “T”-shaped piston bracket used in the invention of U.S. Pat. No. 6,682,495, which was entirely made of metal, is a rigid body. Thus, the bed disclosed in U.S. Pat. No. 6,682,495, the manipulation between the vibratable plate, the “T”-shaped piston bracket, and the connecting rod was reluctant to vibrate freely in three dimensions. Accordingly, the connecting rod must be twisted and swiveled not only against the “T”-shaped piston bracket which is attached to the stationary plate, but also against the crank pin.

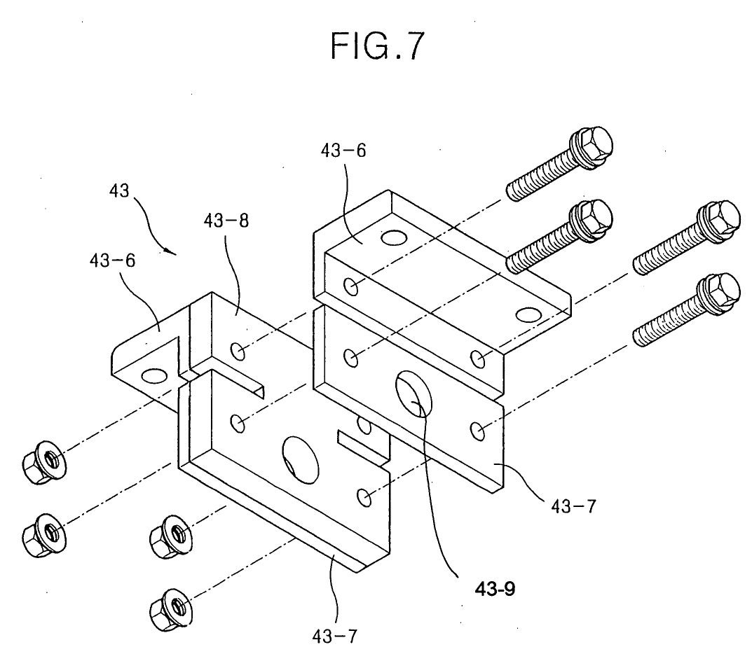

In order to solve this problem, the “T”-shaped piston bracket (43) of the present application is resilient. The “T”-shaped piston bracket (43) of the present application is made of resilient reinforced parts to be twisted and swiveled by the connecting rod (39) for free vibrations of the vibratable plate(11) in three dimensions. For this purpose, a “T”-shaped piston bracket (43) is designed as shown in FIG. 7.

The “T”-shaped piston bracket (43, 43′) includes a resilient square plate (43-8, 43-8′), a pair of “L” angles (43-6, 43-6′) and a pair of vertical plates (43-7, 43-7′). The mid portion of the resilient square plate (43-8, 43-8′) is cut off from the resilient square plate (43-8, 43-8′) to have a shape of narrow dumbbells in its middle as shown in FIG. 7. A pair of“L” angles(43-6, 43-6′) which have bolt holes are attached by bolts and nuts to the upper portion of the resilient square plate (43-8, 43-8′) so that the resilient square plate (43-8, 43-8′) is connected to the vibratable plate (11). The pair of vertical plates (43-7,43-7′) are attached to the lower portion of the resilient square plate (43-1 8,43-8′), by bolts and nuts. The resilient square plate (43-8) and the pair of vertical plates (43-7,43-7′) have a through hole (43-9) through which the connecting rod is inserted as shown in FIG. 7.

It is also remarked that the inside surface of the outer race and the outside surface of the inner race of the crank pin bearing (33, 33′) must be a spherical surface in order to make the connecting rod (39, 39′) swiveled and twisted around in three dimensions against the crank pin (31, 31′).

The first minor part and the second minor part are the first adjusting device and the second adjusting device which are involved in the first and the second rotary reciprocating mechanisms, respectively. The second connecting rod adjusting device is as same as the first connecting rod adjusting device except for that its direction is turned by 90°. One of the threaded ends of the connecting rod (39, 39′) is inserted into the through hole (43-9) provided in the vertical portion of the “T”-shaped piston bracket (43, 43′) and its length is adjusted by the nuts (41, 41′) in order to properly locate the vibratable plate (11). The neutral position of the vibratable plate (11) eliminates the jerky vibrations and noises.

The third minor part and the fourth minor part are the first piston bracket seating device and the second piston bracket seating device which are involved in the first and the second rotary reciprocating mechanisms, respectively. The second piston bracket seating device is as same as the first piston bracket seating device except that its direction is turned by 90°. The first seating device and the second seating device make the “T”-shaped piston brackets (43,43′) repeatedly seated in the fixed location, that is, in the seat groove (43-2,43-2′) provided in the “T”-shaped piston bracket seat (43-1, 43-1′) which is attached on the lower and lateral end side of the vibratable plate (11) along with the “T”-shaped piston bracket back plate (43-3, 43-3′).

The first and the second seating devices are necessary for reinstalling the “T”-shaped piston brackets (43, 43′) in the same position after they was removed from the bed in order to move or transport safely.

Additionally, an electric plug (9) is used for leading the power to a timer switch, which is used for adjusting the bed operating time period for periodic or intermediate. The inverter and a remote controller (10) may be used for adjusting the vibrating speed of the bed.

The main effects of the present invention are far higher than those of my previous inventions because the present invention can vibrate in three dimensions while the previous ones can vibrate only in one dimension. Moreover the synergy effect is practically more than 6 times by feeling.

Particularly, in case of love making, the synergy effect is remarkable.

When a couple are making love on it, the upper partner wants lower partner to make more severe body movements for more escalated pleasure. However, the lower partner is unable to move or vibrate by oneself because the lower partner is pressed by the weight of the upper partner. The vibrating bed of the present invention assists in the lower partner's moving. When a couple is on the three dimensional vibrating bed, they are wholly vibrated in three dimensions, i.e., laterally, longitudinal, and vertically, by the vibrating bed.

The sexual feelings of both partners become more increased due to the inertia force reaction/lag between both partners vibrated by the vibration of the present invention, which in turn generates more and extra pleasure for both partners. It could be truly said that the present three dimensional automatic vibrating bed will provide a human being with more pleasure and happiness.

Because the present invention may vibrate the human body in three dimensions with relatively high frequencies and amplitude without noises, the body's blood vessels are also shaken and vibrated.

What is claimed is:

1. A bed, comprising:
a bed frame comprising a plurality of legs and a stationary plate secured at the top of said plurality of legs, said stationary plate having at least one elongated hole;
a plurality of resilient pillars secured on said stationary plate;
a vibratable plate movably mounted on said plurality of resilient pillars;
a rotatory-reciprocating mechanism for horizontally vibrating said vibratable plate, said rotatory-reciprocating mechanism comprising a motor mounted on said stationary plate, a motor shaft, a first pulley mounted on said motor shaft, a pulley shaft, a second pulley mounted on said pulley shaft, a belt engaged with said first pulley and said second pulley to deliver a motor power to said pulley shaft, an eccentric crank pin in a mid portion of said pulley shaft, a crank pin bearing mounted on said eccentric crank pin, a bearing case mounted on said crank pin bearing, and a connecting rod connected to said bearing case to make a rotary-reciprocating movement;
a plurality of T-shaped brackets being resilient, each T-shaped bracket secured on the bottom of said vibratable plate to connect said connecting rod to said vibratable plate through said elongated hole, wherein a length of said connecting rod between said T-shaped bracket and said bearing case can be adjusted; and
a plurality of first tension spring sets and a plurality of second tension spring sets connecting said vibratable plate to said stationary plate for compensating an inertia force of said vibratable plate and a user's body weight on said vibratable plate, a force direction of said first tension spring sets and a force direction of said second tension spring sets being perpendicular to each other.

2. The bed of claim 1, wherein said rotatory-reciprocating mechanism comprises a first rotatory reciprocating mechanism to vibrate said vibratable plate laterally.

3. The bed of claim 2, wherein said T-shaped bracket is made of resilient reinforced material to be twisted and swiveled for freely vibrating said vibratable plate.

4. The bed of claim 2, further comprising:
a bracket seat mounted on a bottom of said vibratable plate, said bracket seat having a groove for positioning said T-shaped bracket; and
a bracket back plate mounted on a top of said vibratable plate corresponding to said bracket seat.

5. The bed of claim 2, wherein each of said plurality of resilient pillars comprises a cylindrical compression coil spring.

6. The bed of claim 1, wherein said rotatory-reciprocating mechanism comprises a second rotatory reciprocating mechanism to vibrate said vibratable plate longitudinally.

7. The bed of claim 6, wherein said T-shaped bracket is made of resilient reinforced material to be twisted and swiveled for freely vibrating said vibratable plate.

8. The bed of claim 6, further comprising:
a bracket seat mounted on a bottom of said vibratable plate, said bracket seat having a groove for positioning said T-shaped bracket; and
a bracket back plate mounted on a top of said vibratable plate corresponding to said bracket seat.

9. The bed of claim 6, wherein each of said plurality of resilient pillars comprises a cylindrical compression coil spring.

10. The bed of claim 1, wherein said rotatory-reciprocating mechanism comprises a first rotatory reciprocating mechanism to vibrate said vibratable plate laterally and a second rotatory reciprocating mechanism to vibrate said vibratable plate longitudinally.

11. The bed of claim 10, wherein said T-shaped bracket is made of resilient reinforced material to be twisted and swiveled for freely vibrating said vibratable plate.

12. The bed of claim 10, further comprising:
a bracket seat mounted on a bottom of said vibratable plate, said bracket seat having a groove for positioning said T-shaped bracket; and
a bracket back plate mounted on a top of said vibratable plate corresponding to said bracket seat.

13. The bed of claim 10, wherein each of said plurality of resilient pillars comprises a cylindrical compression coil spring.

14. The bed of claim 1, wherein the crank pin bearing has a spherical shape of the inside surface of the outer race and the outside surface of the inner race to make the connecting rod swiveled and twisted around in three dimensions against the crank pin.

15. A bed, comprising:
a bed frame comprising a plurality of legs and a stationary plate secured at the top of said plurality of legs, said stationary plate having a plurality of elongated holes;
a plurality of resilient pillars secured on said stationary plate;
a vibratable plate movably mounted on said plurality of resilient pillars;
a first rotatory-reciprocating mechanism and a second rotatory reciprocating mechanism, each of said first and second rotatory reciprocating mechanisms comprising a motor mounted on said stationary plate, a motor shaft, a first pulley mounted on said motor shaft, a pulley shaft, a second pulley mounted on said pulley shaft, a belt engaged with said first pulley and said second pulley to deliver a motor power to said pulley shaft, an eccentric crank pin in a mid portion of said pulley shaft, a crank pin bearing mounted on said eccentric crank pin, a bearing case mounted on said crank pin bearing, a connecting rod connected to said bearing case to make a rotary-reciprocating movement, wherein said first rotatory-reciprocating mechanism and said second rotatory reciprocating mechanism are arranged perpendicularly to each other;
a plurality of T-shaped brackets being resilient, each T-shaped bracket secured on the bottom of said vibratable plate to connect each said connecting rod to said vibratable plate through each said elongated hole, wherein a length of said connecting rod between said T-shaped bracket and said bearing case can be adjusted; and
a plurality of first tension spring sets and a plurality of second tension spring sets connecting said vibratable plate to said stationary plate for compensating an inertia force of said vibratable plate and a user's body weight on said vibratable plate, a force direction of said first tension spring sets and a force direction of said second tension springs being perpendicular to each other.

16. The bed of claim 15, wherein said T-shaped bracket is made of resilient reinforced material to be twisted and swiveled for freely vibrating said vibratable plate.

17. The bed of claim 10, further comprising:
a plurality of bracket seats, each bracket seat mounted on a bottom of said vibratable plate, said bracket seat having a groove for positioning each said T-shaped bracket; and
a plurality of bracket back plates mounted on a top of said vibratable plate corresponding to said plurality of bracket seats.

18. The bed of claim 1, wherein the crank pin bearing has a spherical shape of the inside surface of the outer race and the outside surface of the inner race to make the connecting rod swiveled and twisted around in three dimensions against the crank pin.

19. The bed of claim 10, wherein each of said plurality of resilient pillars comprises a cylindrical compression coil spring.

20. A bed, comprising:
a bed frame comprising a plurality of legs and a stationary plate secured at the top of said plurality of legs, said stationary plate having a plurality of elongated holes;
a plurality of resilient pillars secured on said stationary plate, each of said plurality of resilient pillars comprising a cylindrical compression coil spring;
a vibratable plate movably mounted on said plurality of resilient pillars;
a first rotatory-reciprocating mechanism and a second rotatory reciprocating mechanism, each of said first and second rotatory reciprocating mechanisms comprising a motor mounted on said stationary plate, a motor shaft, a first pulley mounted on said motor shaft, a pulley shaft, a second pulley mounted on said pulley shaft, a belt engaged with said first pulley and said second pulley to deliver a motor power to said pulley shaft, an eccentric crank pin in a mid portion of said pulley shaft, a crank pin bearing mounted on said eccentric crank pin, a bearing case mounted on said crank pin bearing, a connecting rod connected to said bearing case to make a rotary-reciprocating movement, wherein said first rotatory-reciprocating mechanism and said second rotatory reciprocating mechanism are arranged perpendicularly to each other;
a plurality of T-shaped brackets made of resilient reinforced material to be twisted and swiveled for freely vibrating said vibratable plate, each T-shaped bracket secured on the bottom of said vibratable plate to connect each said connecting rod to said vibratable plate through each said elongated hole, wherein a length of said connecting rod between said T-shaped bracket and said bearing case can be adjusted;
a plurality of bracket seats, each bracket seat mounted on a bottom of said vibratable plate, said bracket seat having a groove for positioning each said T-shaped bracket;
a plurality of bracket back plates mounted on a top of said vibratable plate corresponding to said plurality of bracket seats; and
a plurality of first tension spring sets and a plurality of second tension spring sets connecting said vibratable plate to said stationary plate for compensating an inertia force of said vibratable plate and a user's body weight on said vibratable plate, a force direction of said first tension spring sets and a force direction of said second tension springs being perpendicular to each other.
